(19) United States
(12) Patent Application Publication
(10) Pub. No.: US 2025/0011601 A1
(43) Pub. Date: Jan. 9, 2025

(54) WATER-BASED THERMAL-INSULATION COATING MATERIAL

(71) Applicant: NAN YA PLASTICS CORPORATION, TAIPEI (TW)

(72) Inventors: TE-CHAO LIAO, TAIPEI (TW); CHUN-CHE TSAO, TAIPEI (TW); Yueh-Shin Liu, Taipei City (TW); Yi-Chen Chou, TAIPEI (TW)

(21) Appl. No.: 18/469,510

(22) Filed: Sep. 18, 2023

(30) Foreign Application Priority Data
Jul. 7, 2023 (TW) 112125367

(51) Int. Cl. C09D 5/02; C09D 7/20; C09D 7/61; C09D 133/06; F16L 59/02

(52) U.S. Cl. CPC C09D 5/022; C09D 5/028; C09D 7/20; C09D 7/61; C09D 133/064; F16L 59/028

(57) ABSTRACT

A water-based thermal-insulation coating material includes a water-based resin, a film forming auxiliary agent, and a thermal insulation agent. The water-based resin is at least one material selected from a group consisting of: acrylic resins, polyurethane resins, epoxy resins, and combinations thereof. The water-based resin has a minimum film-forming temperature of not less than 5° C. The film forming auxiliary agent is at least one material selected from a group consisting of: plasticizers, alcohol-ether solvents, alcohol-ester solvents, a mixed solvent of ethylene glycol mono-butyl ether and di-propylene glycol butyl ether, aprotic solvents, and combinations thereof. The thermal insulation agent is hydrated silicon dioxide.

### CROSS-REFERENCE TO RELATED PATENT APPLICATION

This application claims the benefit of priority to Taiwan Patent Application No. 112125367, filed on Jul. 7, 2023. The entire content of the above identified application is incorporated herein by reference.

Some references, which may include patents, patent applications and various publications, may be cited and discussed in the description of this disclosure. The citation and/or discussion of such references is provided merely to clarify the description of the present disclosure and is not an admission that any such reference is “prior art” to the disclosure described herein. All references cited and discussed in this specification are incorporated herein by reference in their entireties and to the same extent as if each reference was individually incorporated by reference.

### FIELD OF THE DISCLOSURE

The present disclosure relates to a coating material, and more particularly to a water-based thermal-insulation coating material.

### BACKGROUND OF THE DISCLOSURE

In the related art, conventional coating materials of color steel plates and automotive paints are mostly solvent-based. Such coating materials are often dried through a high-temperature baking process. However, during the high-temperature baking process of the solvent-based coating materials, excessive solvent volatilization often occurs and thereby causes environmental pollution.

In order to solve the problem of excessive solvent volatilization, water-based coating materials are also used to be coated on the color steel plates and the automotive paints. However, since the water-based coating materials may prematurely form into coating films during a high-temperature film forming process (e.g., 250° C.), surfaces of the coating films often have defects such as pinholes, blisters, and cracks, and are poor in adhesion strength.

### SUMMARY OF THE DISCLOSURE

In order to cooperate with conventional equipment of a color steel factory, one purpose of the present disclosure is to provide an improved water-based thermal-insulation coating material, which can replace existing solvent-based coating materials without changing manufacturing processes and conditions of the conventional equipment, and effectively solve a problem of excessive solvent volatilization. Since the water-based thermal-insulation coating material provided by the present disclosure has an excellent thermal insulation ability, energy saving and carbon reduction effects can be achieved.

In order to solve the above-mentioned problems, one of the technical aspects adopted by the present disclosure is to provide a water-based thermal-insulation coating material that includes a water-based resin, a film forming auxiliary agent, and a thermal insulation agent. The water-based resin is at least one material selected from a group consisting of: acrylic resins, polyurethane resins, epoxy resins, and combinations thereof. The water-based resin has a minimum film-forming temperature of not less than 5° C. The film forming auxiliary agent is at least one material selected from a group consisting of: plasticizers, alcohol-ether solvents, alcohol-ester solvents, a mixed solvent of ethylene glycol mono-butyl ether and di-propylene glycol butyl ether, aprotic solvents, and combinations thereof. The thermal insulation agent is hydrated silicon dioxide.

In one of the possible or preferred embodiments, the water-based resin is formed by a water-based resin composition through an emulsion polymerization reaction, and the water-based resin composition includes: water, mixed monomers, and an emulsifier. The mixed monomers include: a first monomer, a second monomer, a third monomer, and a fourth monomer. The first monomer is an acrylate monomer, the second monomer is an alkyl-containing methacrylate monomer, the third monomer is a styrene group-containing monomer, and the fourth monomer is a carboxyl group-containing monomer.

In one of the possible or preferred embodiments, a weight ratio among water, the first monomer, the second monomer, the third monomer, the fourth monomer, and the emulsifier is 110 to 150:20 to 50:5 to 30:15 to 40:10 to 35:1 to 5.

In one of the possible or preferred embodiments, the weight ratio among water, the first monomer, the second monomer, the third monomer, the fourth monomer, and the emulsifier is 120 to 140:30 to 45:8 to 25:20 to 35:15 to 30:2 to 5.

In one of the possible or preferred embodiments, the water-based resin has the minimum film-forming temperature of not less than 25° C.

In one of the possible or preferred embodiments, the water-based resin has the minimum film-forming temperature of between 25° C. and 45° C.

In one of the possible or preferred embodiments, the film forming auxiliary agent has a boiling point of between 200° C. and 400° C.; and has the following volatility characteristics:
(1) the film forming auxiliary agent has a relative volatilization rate of 0.005 to 5 based on a volatilization rate of butyl acetate being 100; and (2) the film forming auxiliary agent has an absolute volatilization rate of 0.1 g/(1000 cm² h) to 1.0 g/(1000 cm² h) measured at 100° C.

In one of the possible or preferred embodiments, the hydrated silicon dioxide is prepared by a sol-gel method, and is anionic particles. Each of the anionic particles has a specific surface area between 30.1 m²/g and 100 m²/g.

In one of the possible or preferred embodiments, the water-based thermal-insulation coating material further includes inorganic powders, which are at least one material selected from a group consisting of: titanium dioxide, aluminum hydroxide, magnesium hydroxide, calcium carbonate, calcium phosphate, calcium sulfate, aluminum oxide, zirconium dioxide, zinc oxide, talcum powders, kaolin clay, muscovite, expanded perlite, inorganic colorants, and combinations thereof.

In one of the possible or preferred embodiments, based on a total weight of the water-based thermal-insulation coating material being 100 wt %, a content of the water-based resin is between 55 wt % and 85 wt %, a content of the film forming auxiliary agent is between 2 wt % and 20 wt %, and a content of the thermal insulation agent is between 1 wt % and 10 wt %.

Therefore, the water-based thermal-insulation coating material provided by the present disclosure can effectively reduce carbon emissions, replace the existing solvent-based coating materials, and have a thermal insulating effect. In addition, the water-based thermal-insulation coating material provided by the present disclosure is particularly suitable for a high-temperature drying process. Through selection of the water-based resin and the film forming auxiliary agent, the water-based thermal-insulation coating material of the present disclosure can replace the existing solvent-based coating materials without changing the manufacturing processes and conditions of the conventional equipment.

These and other aspects of the present disclosure will become apparent from the following description of the embodiment taken in conjunction with the following drawings and their captions, although variations and modifications therein may be affected without departing from the spirit and scope of the novel concepts of the disclosure.

### DETAILED DESCRIPTION OF THE EXEMPLARY EMBODIMENTS

The present disclosure is more particularly described in the following examples that are intended as illustrative only since numerous modifications and variations therein will be apparent to those skilled in the art. Like numbers in the drawings indicate like components throughout the views. As used in the description herein and throughout the claims that follow, unless the context clearly dictates otherwise, the meaning of “a”, “an”, and “the” includes plural reference, and the meaning of “in” includes “in” and “on”. Titles or subtitles can be used herein for the convenience of a reader, which shall have no influence on the scope of the present disclosure.

The terms used herein generally have their ordinary meanings in the art. In the case of conflict, the present document, including any definitions given herein, will prevail. The same thing can be expressed in more than one way. Alternative language and synonyms can be used for any term(s) discussed herein, and no special significance is to be placed upon whether a term is elaborated or discussed herein. A recital of one or more synonyms does not exclude the use of other synonyms. The use of examples anywhere in this specification including examples of any terms is illustrative only, and in no way limits the scope and meaning of the present disclosure or of any exemplified term. Likewise, the present disclosure is not limited to various embodiments given herein. Numbering terms such as “first”, “second” or “third” can be used to describe various components, signals or the like, which are for distinguishing one component/signal from another one only, and are not intended to, nor should be construed to impose any substantive limitations on the components, signals or the like.

### [Water-Based Thermal-Insulation Coating Material]

An embodiment of the present disclosure provides a water-based thermal-insulation coating material, which can replace existing solvent-based coating materials without changing manufacturing processes and conditions of conventional equipment. The water-based thermal-insulation coating material includes: a water-based resin, a film forming auxiliary agent, a thermal insulation agent, and inorganic powders.

The water-based resin has the following material characteristics.

The water-based resin can be, for example, at least one material selected from a group consisting of: acrylic resins, polyurethane resins, epoxy resins, and combinations thereof.

Furthermore, the water-based resin preferably has a minimum film-forming temperature (MFFT) of not less than 5° C., preferably not less than 25° C., and more preferably between 25° C. and 45° C.

It should be noted that the minimum film-forming temperature (MFFT) mentioned herein refers to a minimum temperature at which a resin is uniformly coalesced when the resin is coated on a substrate. In the present embodiment, the minimum film-forming temperature (MFFT) is measured according to the standard of ISO 2115.

In some embodiments of the present disclosure, the water-based resin is an acrylic resin, and the minimum film-forming temperature (MFFT) of the water-based resin can be adjusted by formulating monomers. For example, the water-based resin is formed by a water-based resin composition through an emulsion polymerization reaction. The water-based resin composition includes: water, mixed monomers, and an emulsifier. The mixed monomers include: a first monomer (first monomers), a second monomer (second monomers), a third monomer (third monomers), and a fourth monomer (fourth monomers).

The first monomer is an acrylate monomer, the second monomer is an alkyl-containing methacrylate monomer, the third monomer is a styrene group-containing monomer, and the fourth monomer is a carboxyl group-containing monomer.

In a specific embodiment, the first monomer is butyl acrylate (BA). The second monomer is methyl (meth) acrylate (MMA). The third monomer is styrene (i.e., a styrene monomer (SM)). The fourth monomer is meth-acrylic acid (MAA).

Furthermore, the emulsifier can be, for example, selected from the group consisting of reactive emulsifiers, anionic emulsifiers, and cationic emulsifiers. Preferably, the emulsifier is the reactive emulsifier (e.g., SR-10), but the present disclosure is not limited thereto.

In terms of a content range, a weight ratio among water, the first monomer (i.e., the acrylate monomer, such as BA), the second monomer (i.e., the alkyl-containing methacrylate monomer, such as MMA), the third monomer (i.e., the styrene group-containing monomer, such as SM), the fourth monomer (i.e., the carboxyl group-containing monomer, such as MAA), and the emulsifier can be, for example, 110 to 150 (water): 20 to 50 (the first monomer): 5 to 30 (the second monomer): 15 to 40 (the third monomer): 10 to 35 (the fourth monomer): 1 to 5 (the emulsifier). Preferably, the weight ratio can be, for example, 120 to 140 (water): 30 to 45 (the first monomer): 8 to 25 (the second monomer): 20 to 35 (the third monomer): 15 to 30 (the fourth monomer): 2 to 5 (the emulsifier). More preferably, the weight ratio can be, for example, 125 to 135 (water): 33 to 40 (the first monomer): 10 to 20 (the second monomer): 25 to 30 (the third monomer): 20 to 25 (the fourth monomer): 3 to 5 (the emulsifier).

According to the above configuration, the water-based resin has the minimum film-forming temperature of not less than 5° C., preferably not less than 25° C., and more preferably between 25° C. and 45° C.

It is worth mentioning that among the mixed monomers mentioned above, the first monomer (i.e., the acrylate monomer) is a monomer that allows the water-based resin to have a low glass transition temperature (low Tg) property, so as to enable a finally formed resin coating film to have excellent adhesion. The second monomer (i.e., the methacrylate monomer) is a monomer that allows the water-based resin to have a high glass transition temperature (high Tg) property, so as to increase the minimum film-forming temperature of the water-based resin. The third monomer (i.e., the styrene group-containing monomer) is a hydrophobic monomer, which has a polarity difference with water molecules, and enables the finally formed resin coating film to have excellent water soak resistance and scratch resistance.

A molecular chain of the fourth monomer (i.e., the carboxyl group-containing monomer) has a negative charge after being dissociated in a water phase environment, and the negative charge of the fourth monomer can be combined with a positive charge of the inorganic powder (e.g., TiO₂), so that the inorganic powder can be dispersed and stabilized in the resin coating film. Therefore, the resin coating film can have excellent scratch resistance and be less prone to chalking. In addition, a molecular structure of the fourth monomer has a carboxyl group. The carboxyl group of the fourth monomer can interact with a bridging agent of the water-based resin, so that the resin coating film can form a network structure. As such, a mechanical strength of the resin coating film can be increased.

It is worth mentioning that, when the minimum film-forming temperature of the water-based resin is controlled within the above-mentioned range, the water-based thermal-insulation coating material does not prematurely form into a resin coating film within a short time during a high-temperature drying process. Accordingly, moisture and additives in the water-based thermal-insulation coating material can still overflow to a surface of the water-based thermal-insulation coating material at a high temperature, so that a surface of the resin coating film that is finally formed can become smooth. In this way, problems in the related art, such as generation of pinholes, blisters, and cracks on the surface of the resin coating film, and poor adhesion of the resin coating film, can be effectively improved.

The film forming auxiliary agent has the following material characteristics.

The film forming auxiliary agent (also referred to as a film-forming aid) can aid in improving a film-forming ability of the water-based thermal-insulation coating material, and in preventing generation of cracks and damage when the water-based thermal-insulation coating material is dried.

In some embodiments of the present disclosure, the film forming auxiliary agent is at least one material selected from a group consisting of: plasticizers, alcohol-ether solvents, alcohol-ester solvents, a mixed solvent of ethylene glycol mono-butyl ether and di-propylene glycol butyl ether, aprotic solvents, and combinations thereof.

It is worth mentioning that the film forming auxiliary agent has a boiling point between 200° C. and 400° C., and preferably between 225° C. and 375° C. In addition, based on a volatilization rate of butyl acetate being 100, the film forming auxiliary agent has a relative volatilization rate of from 0.005 to 5, and preferably from 0.01 to 3. Alternatively, the film forming auxiliary agent has an absolute volatilization rate of from 0.1 g/(1000 cm² h) to 1.0 g/(1000 cm² h) measured at 100° C., and preferably from 0.5 g/(1000 cm² h) to 0.8 g/(1000 cm² h) measured at 100° C.

For example, the film forming auxiliary agent can be 2,2,4-trimethyl-1,3-pentanediol diisobutyrate (TXIB™), which is a plasticizer having a boiling point of 281° C. and an absolute volatilization rate of 0.674 g/(1000 cm² h) measured at 100° C.

In one embodiment, the film forming auxiliary agent can be dioctyl terephthalate (DOTP), which is a plasticizer having a boiling point of 375° C. and a relative volatilization rate of 0.01 based on the volatilization rate of butyl acetate being 100.

In one embodiment, the film forming auxiliary agent is diethylene glycol monohexyl ether (DEGME), which is an alcohol-ether solvent having a boiling point of 259° C. and a relative volatilization rate of 1 based on the volatilization rate of butyl acetate being 100.

In one embodiment, the film forming auxiliary agent is triethylene glycol monobutyl ether (TEGME), which is an alcohol-ether solvent having a boiling point of 275° C. and a relative volatilization rate of 0.06 based on the volatilization rate of butyl acetate being 100.

In one embodiment, the film forming auxiliary agent is Texanol™ alcohol ester, which is an alcohol-ester solvent having a boiling point of 254° C. and a relative volatilization rate of 0.2 based on the volatilization rate of butyl acetate being 100.

In one embodiment, the film forming auxiliary agent is Optifilm™ enhancer 300 (OE300), which has a boiling point of 281° C. and a relative volatilization rate of 0.04 based on the volatilization rate of butyl acetate being 100.

In one embodiment, the film forming auxiliary agent is 1,3-dimethyl-2-imidazolidinone (DMI), which is an aprotic solvent having a boiling point of 225° C., and a relative volatilization rate of 3 based on the volatilization rate of butyl acetate being 100.

Alternatively, the film forming auxiliary agent can be at least one of Texanol™ ester alcohol, ethylene glycol mono-butyl ether (BCS), and di-(2-ethylhexyl) terephthalate (DEHT) according to practical requirements.

It is worth mentioning that, in one exemplary embodiment of the present disclosure, the film forming auxiliary agent mentioned above can be, for example, a composite auxiliary agent in which two or more auxiliary agents are selected at the same time. For example, the film-forming auxiliary agent can be a composite auxiliary agent in which TXIB and DOTP are selected at the same time. Alternatively, the film-forming auxiliary agent can be a composite auxiliary agent in which DEGME and OE300 are selected at the same time. In addition, a volume ratio range between the two solvents can be, for example, 30 to 70:30 to 70, and preferably 40 to 60:40 to 60, but the present disclosure is not limited thereto.

In addition, it is worth mentioning that, based on a total weight of the water-based thermal-insulation coating material being 100 wt %, a content of the film forming auxiliary agent is between 2 wt % and 20 wt %, so that the water-based thermal-insulation coating material can have a better film-forming effect. If the content of the film forming auxiliary agent is less than 2 wt %, the water-based thermal-insulation coating material cannot achieve the film-forming effect. If the content of the film forming auxiliary agent is greater than 20 wt %, the water-based thermal-insulation coating material is likely to be delaminated or gelled.

Furthermore, the film forming auxiliary agent has a relatively high boiling point and a relatively low volatilization rate. Therefore, the film forming auxiliary agent will not completely volatilize during the high-temperature drying process, and the film forming auxiliary agent can still overflow to the surface of the water-based thermal-insulation coating material at the high temperature, so that the surface of the resin coating film becomes smooth. In this way, the problems in the related art, such as generation of pinholes, blisters, and cracks on the surface of the resin coating film, and poor adhesion of the resin coating film, can be effectively improved.

The thermal insulation agent has the following material characteristics.

The thermal insulation agent is silicon dioxide prepared by a sol-gel method, and the thermal insulation agent is preferably hydrated silicon dioxide.

In some embodiments of the present disclosure, the silicon dioxide prepared by the sol-gel method is anionic particles, and each of the anionic particles has a specific surface area of between 30.1 m²/g and 100 m²/g.

In addition, the anionic particles can be suspended in a sodium ion solution or an ammonium ion solution, and a pH value of the above-mentioned solution is preferably controlled between pH 9 and pH 10, so as to maintain the stability of the solution and the dispersion of the anionic particles.

According to the above configuration, introducing the thermal insulation agent into the water-based thermal-insulation coating material can effectively improve thermal-insulation performance of the water-based thermal-insulation coating material.

The inorganic powders have the following material characteristics.

The inorganic powders are at least one material selected from a group consisting of: titanium dioxide (TiO₂), aluminum hydroxide (Al(OH)₃), magnesium hydroxide (Mg(OH)₂), calcium carbonate (CaCO₃), calcium phosphate (Ca₃(PO₄)₂), calcium sulfate (CaSO₄), aluminum oxide (Al₂O₃), zirconium dioxide (ZrO₂), zinc oxide (ZnO), talcum powders (Mg₃Si₄O₁₀(OH)₂), kaolin clay (Al₂Si₂O₅(OH)₄), muscovite (MICA), expanded perlite, inorganic colorants, and combinations thereof.

In some embodiments of the present disclosure, the inorganic powders have an average particle size (i.e., D50) of between 0.08 micrometers and 3 micrometers, and preferably between 0.1 micrometers and 0.3 micrometers.

If the average particle size of the inorganic powders is too large, the inorganic powders cannot be uniformly dispersed in the water-based thermal-insulation coating material by stirring.

If the average particle size of the inorganic powders is too small, thixotropy will be too high, thereby resulting in uneven distribution of the inorganic powders when being stirred.

In terms of a content range of each component, based on the total weight of the water-based thermal-insulation coating material being 100 wt %, a content of the water-based resin is between 55 wt % and 85 wt %, preferably between 60 wt % and 80 wt %, and more preferably between 62 wt % and 75 wt %; a content of the film forming auxiliary agent is between 2 wt % and 20 wt %, preferably between 3 wt % and 15 wt %, and more preferably between 5 wt % and 15 wt %; a content of the thermal insulation agent is between 1 wt % and 10 wt %, preferably between 2 wt % and 8 wt %, and more preferably between 3 wt % and 6 wt %; and a content of the inorganic powders is between 5 wt % and 25 wt %, preferably between 10 wt % and 20 wt %, and more preferably between 13 wt % and 17 wt %. However, the present disclosure is not limited thereto.

Therefore, the water-based thermal-insulation coating material provided by the embodiment of the present disclosure can effectively reduce carbon emissions, replace the existing solvent-based coating materials, and have a thermal insulating effect.

In addition, the water-based thermal-insulation coating material provided by the embodiment of the present disclosure is particularly suitable for the high-temperature (e.g., 250° C.) drying process.

Through selection of the water-based resin and the film forming auxiliary agent, the water-based thermal-insulation coating material of the present disclosure can replace the existing solvent-based coating materials without changing the manufacturing processes and conditions of the conventional equipment.

### [Experimental Data and Test Results]

Hereinafter, a detailed description will be provided with reference to the following experimental data and test results. However, the examples below are only provided to help understanding of the present disclosure, and are not to be construed as limiting the scope of the present disclosure. Here, Exemplary Examples 1 to 3 can prove the technical effects of the present disclosure, while Comparative Example 1 has poor test results. Water-based resins having different minimum film-forming temperatures (MFFT) are firstly prepared according to Preparation Examples 1 to 3, and the water-based resins of Preparation Examples 1 to 3 can be used in Exemplary Examples 1 to 3, respectively.

The water-based resin of Preparation Example 1 is prepared according to Formula 1 of Table 1. In Preparation Example 1, 130 parts by weight of pure water, 40 parts by weight of butyl acrylate (BA), 10 parts by weight of methyl (meth)acrylate (MMA), 30 parts by weight of styrene (SM), 20 parts by weight of methacrylic acid (MAA), and 4 parts by weight of an emulsifier (i.e., a reactive emulsifier SR-10) are mixed by a mixer to form a pre-emulsion. Then, the pre-emulsion is added into a reaction tank to perform an emulsification reaction, and the water-based resin having a minimum film-forming temperature (MFFT) of 25° C. is finally prepared. The definition of the minimum film-forming temperature has been described above and will not be repeated herein.

The water-based resin of Preparation Example 2 is prepared according to Formula 2 of Table 1. In Preparation Example 2, 130 parts by weight of pure water, 35 parts by weight of butyl acrylate (BA), 20 parts by weight of methyl (meth)acrylate (MMA), 25 parts by weight of styrene (SM), 20 parts by weight of methacrylic acid (MAA), and 4 parts by weight of an emulsifier (i.e., a reactive emulsifier SR-10) are mixed by a mixer to form a pre-emulsion. Then, the pre-emulsion is added into a reaction tank to perform an emulsification reaction, and the water-based resin having a minimum film-forming temperature (MFFT) of 30° C. is finally prepared.

The water-based resin of Preparation Example 3 is prepared according to Formula 3 of Table 1. In Preparation Example 3, 130 parts by weight of pure water, 33 parts by weight of butyl acrylate (BA), 16 parts by weight of methyl (meth)acrylate (MMA), 26 parts by weight of styrene (SM), 25 parts by weight of methacrylic acid (MAA), and 4 parts by weight of an emulsifier (i.e., a reactive emulsifier SR-10) are mixed by a mixer to form a pre-emulsion. Then, the pre-emulsion is added into a reaction tank to perform an emulsification reaction, and the water-based resin having a minimum film-forming temperature (MFFT) of 40° C. is finally prepared.

TABLE 1
Formulas and Physical Properties of Water-Based Resin

| | Items | Formula 1 | Formula 2 | Formula 3 |
|---|---|---|---|---|
| Formulas | Amount of | 130 | 130 | 130 |
| and | pure water | | | |
| physical | (parts by weight) | | | |
| properties | Amount of fist monomer | 40 | 35 | 33 |
| of | butyl acrylate (BA) | | | |
| water-based | (parts by weight) | | | |
| resin | Amount of second monomer - | 10 | 20 | 16 |
| | methyl (meth)acrylate (MMA) | | | |
| | (parts by weight) | | | |
| | Amount of third monomer | 30 | 25 | 26 |
| | styrene (SM) | | | |
| | (parts by weight) | | | |
| | Amount of fourth monomer | 20 | 20 | 25 |
| | methacrylic acid (MAA) | | | |
| | (parts by weight) | | | |
| | Amount of emulsifier (SR-10) | 4.0 | 4.0 | 4.0 |
| | (parts by weight) | | | |
| | minimum film-forming temperature | 25 | 30 | 40 |
| | (MFFT) (° C.) | | | |

The water-based resin adopted in Exemplary Example 1 is the water-based resin that is prepared by Preparation Example 1 and has a minimum film-forming temperature (MFFT) of 25° C. In Exemplary Example 1, a water-based thermal-insulation coating material is prepared according to Table 2. The water-based thermal-insulation coating material includes: 72 wt % of the water-based resin, 5 wt % of a film forming auxiliary agent, 5 wt % of a thermal insulation agent, 17 wt % of inorganic powders, and 1 wt % of other additives (i.e., a dispersing agent and a bridging agent). Then, the water-based thermal-insulation coating material is coated on a composite sheet (that is made of a PET film and a steel plate and has a thickness of 150 μm) by a coating rod having a diameter of 250 μm. The water-based thermal-insulation coating material is dried at a room temperature for 24 hours to form a water-based thermal-insulation coating layer, and then evaluation of various physical properties of said coating layer is conducted.

The water-based resin adopted in Exemplary Example 2 is the water-based resin that is prepared by Preparation Example 2 and has a minimum film-forming temperature (MFFT) of 30° C. In Exemplary Example 2, a water-based thermal-insulation coating material is prepared according to Table 2. The water-based thermal-insulation coating material includes: 75 wt % of the water-based resin, 8 wt % of a film forming auxiliary agent, 3 wt % of a thermal insulation agent, 13 wt % of inorganic powders, and 1 wt % of other additives (i.e., a dispersing agent and a bridging agent). Then, the water-based thermal-insulation coating material is coated on a composite sheet made of a PET film and a steel plate by the above-mentioned coating method. The dried coating layer is evaluated for various physical properties.

The water-based resin adopted in Exemplary Example 3 is the water-based resin that is prepared by Preparation Example 3 and has a minimum film-forming temperature (MFFT) of 40° C. In Exemplary Example 3, a water-based thermal-insulation coating material is prepared according to Table 2. The water-based thermal-insulation coating material includes: 62 wt % of the water-based resin, 15 wt % of a film forming auxiliary agent, 6 wt % of a thermal insulation agent, 16 wt % of inorganic powders, and 1 wt % of other additives (i.e., a dispersing agent and a bridging agent). Then, the water-based thermal-insulation coating material is coated on a composite sheet made of a PET film and a steel plate by the above-mentioned coating method. The dried coating layer is evaluated for various physical properties.

The water-based resin adopted in Comparative Example 1 is an acrylic water-based resin currently available on the market (i.e., P-60 manufactured by SANKYO and having a MFFT of 0° C.).

In Comparative Example 1, a water-based thermal-insulation coating material is prepared according to Table 2. Then, the water-based thermal-insulation coating material is coated on a composite sheet made of a PET film and a steel plate by the above-mentioned coating method. The dried coating layer is evaluated for various physical properties.

Items and test methods for physical property evaluation are described below.

In the evaluation of the appearance of the coating layer, the appearance of a coating layer sample is observed after being dried at a room temperature for 24 hours, so as to evaluate whether the appearance of the coating layer sample is smooth or uneven.

The evaluation of the appearance of the coating layer after being dried at 280° C. is conducted since the water-based thermal-insulation coating material is applied to industrial products, and a coating film is prepared at a high temperature and a high speed in a production line. Accordingly, the above-mentioned water-based thermal-insulation coating layer is coated on the steel plate and dried at a room temperature for 24 hours. Then, a coating layer sample is placed in an oven, and is further dried at a high temperature of 280° C. for 1 minute. The coating layer sample is evaluated as to whether its appearance is normal or is subject to abnormalities (such as blistering, cracking, and shedding).

The evaluation of a thermal insulation temperature difference (C) is conducted according to the standard test method of JG/T 235-2014, so as to test the thermal insulation temperature difference (° C.) of the above-mentioned coating layer sample that is dried at a high temperature of 280° C.

In a drop ball test (200 grams), a drop ball impact tester is used to freely drop a steel ball of 200 grams onto the above-mentioned coating layer sample dried at a high temperature of 280° C. from a predetermined drop height (e.g., 100 cm), so as to observe whether or not the coating layer sample is peeled off from the steel plate.

In the evaluation of MEK wiping for 100 times, a gauze is soaked with methyl ethyl ketone (MEK), and a friction tester is used to wipe the above-mentioned coating layer sample dried at a high temperature of 280° C. by the soaked gauze back and forth for 100 times, so as to observe whether or not the coating layer sample is peeled off from the steel plate.

TABLE 2
Compositions of Water-Based Thermal-Insulation Coating
Material and Test Results of Coating Layer

| | | Exemplary | Exemplary | Exemplary | Comparative |
|---|---|---|---|---|---|
| | | Example 1 | Example 2 | Example 3 | Example 1 |
| Compositions | Content of | 72 | 75 | 62 | 73 |
| of | water-based | | | | |
| Coating | resin (wt %) | | | | |
| Material | MFFT of | 25 | 30 | 40 | 0 |
| | water-based | | | | |
| | resin (° C.) | | | | |
| | Content of | 5 | 8 | 15 | 3 |
| | film forming | | | | |
| | auxiliary agent | | | | |
| | (wt %) | | | | |
| | Material type | TXIB and | DEGME and | TXIB and | TXIB and |
| | of film | DOTP | OE300 | DOTP | BCS |
| | forming | with a volume | with a volume | with a volume | with a volume |
| | auxiliary agent | ratio of 1:1 | ratio of 1:1 | ratio of 1:1 | ratio of 1:1 |
| | Content of | 5 | 3 | 6 | 5 |
| | thermal | | | | |
| | insulation | | | | |
| | agent (wt %) | | | | |
| | Material type | Hydrated | Hydrated | Hydrated | Hydrated |
| | of thermal | silicon | silicon | silicon | silicon |
| | insulation | dioxide | dioxide | dioxide | dioxide |
| | agent | | | | |
| | Content of | 17 | 13 | 16 | 18 |
| | inorganic | | | | |
| | powders | | | | |
| | (wt %) | | | | |
| | Material type | TiO₂ and | TiO₂ and | TiO₂ and | TiO₂ and |
| | of inorganic | MICA | CaCO₃ | Al₂O₃ | MICA |
| | powders | with a weight | with a weight | with a weight | with a weight |
| | | ratio of 1:1 | ratio of 1:1 | ratio of 1:1 | ratio of 1:1 |
| | Content of | 1 | 1 | 1 | 1 |
| | additives | | | | |
| | (wt %) | | | | |
| Test | Appearance of | smooth | smooth | smooth | smooth |
| Results | coating layer | | | | |
| of | after being | | | | |
| Coating | dried at a | | | | |
| Layer | room | | | | |
| | temperature | | | | |
| | for 24 hours | | | | |
| | Appearance of | normal | normal | normal | partially |
| | coating layer | | | | blistered |
| | after being | | | | |
| | further dried at | | | | |
| | 280° C. for | | | | |
| | 1 minute | | | | |
| | Thermal | 10 | 8 | 10 | 5 |
| | insulation | | | | |
| | temperature | | | | |
| | difference | | | | |
| | (° C.) | | | | |
| | Drop ball test | Coating layer | Coating layer | Coating layer | Coating layer |
| | (200 grams) | is normal | is normal | is normal | is peeled off |
| | MEK wiping | Coating layer | Coating layer | Coating layer | Coating layer |
| | for 100 times | is normal | is normal | is normal | is peeled off |

### [Discussion of Test Results]

According to the above test results, in each of Exemplary Examples 1 to 3, the water-based thermal-insulation coating layer is dried at a high temperature of 280° C. for 1 minute, and the surface appearance of the coating layer is normal without any abnormalities (such as blistering, cracking, and peeling). The water-based thermal-insulation coating layer that has been dried at a high temperature is tested, and a thermal insulation temperature difference of between 8° C. and 10° C. can be obtained. The above-mentioned water-based thermal-insulation coating layer is subject to the drop ball test (200 grams), and the test result shows that the coating layer is normal and is not peeled off from the steel plate. The above-mentioned water-based thermal-insulation coating layer is wiped with MEK for 100 times, and the test result shows that the coating layer is normal and is not peeled off from the steel plate. That is, the water-based thermal-insulation coating layers prepared in Exemplary Examples 1 to 3 can be dried at a high temperature, and have excellent thermal insulation, impact resistance, and solvent resistance. These results show that using a water-based resin having a specific minimum film-forming temperature (MFFT) can effectively improve abnormality of the appearance after drying at a high temperature. In addition, good physical properties can be maintained.

In Comparative Example 1, the water-based thermal-insulation coating layer is dried at a high temperature of 280° C. for 1 minute, and the surface appearance of the coating layer is partially blistered and exhibits abnormal characteristics. The water-based thermal-insulation coating layer that has been dried at a high temperature is further tested, and a thermal insulation temperature difference of 5° C. is obtained, which indicates that an insulation effect of the water-based thermal-insulation coating layer of Comparative Example 1 is poor as compared with that of Exemplary Examples 1 to 3. The above-mentioned water-based thermal-insulation coating layer is subject to the drop ball test (200 grams), and the test result shows that the coating layer is peeled off. The above-mentioned water-based thermal-insulation coating layer is wiped with MEK for 100 times, and the test result shows that the coating layer is peeled off. In other words, the water-based thermal-insulation coating layer prepared in Comparative Example 1 is not resistant against a high temperature, and the results of related physical properties are all unsatisfactory.

### Beneficial Effects of the Embodiments

In conclusion, the water-based thermal-insulation coating material provided by the embodiments of the present disclosure can effectively reduce carbon emissions, replace the existing solvent-based coating materials, and have a thermal insulating effect.

In addition, the water-based thermal-insulation coating material provided by the embodiments of the present disclosure is particularly suitable for the high-temperature (e.g., 250° C.) drying process.

Through selection of the water-based resin and the film forming auxiliary agent, the water-based thermal-insulation coating material of the present disclosure can replace the existing solvent-based coating materials without changing the manufacturing processes and conditions of the conventional equipment.

The foregoing description of the exemplary embodiments of the disclosure has been presented only for the purposes of illustration and description and is not intended to be exhaustive or to limit the disclosure to the precise forms disclosed. Many modifications and variations are possible in light of the above teaching.

The embodiments were chosen and described in order to explain the principles of the disclosure and their practical application so as to enable others skilled in the art to utilize the disclosure and various embodiments and with various modifications as are suited to the particular use contemplated. Alternative embodiments will become apparent to those skilled in the art to which the present disclosure pertains without departing from its spirit and scope.

What is claimed is:

1. A water-based thermal-insulation coating material, comprising:
a water-based resin, the water-based resin being selected from the group consisting of: acrylic resins, polyurethane resins, and epoxy resins; wherein a minimum film-forming temperature of the water-based resin is not less than 5° C.;
a film forming auxiliary agent, the film forming auxiliary agent being selected from the group consisting of: plasticizers, alcohol-ether solvents, alcohol-ester solvents, a mixed solvent of ethylene glycol mono-butyl ether and di-propylene glycol butyl ether, and aprotic solvents; and
a thermal insulation agent, the thermal insulation agent being hydrated silicon dioxide.

2. The water-based thermal-insulation coating material according to claim 1, wherein the water-based resin is formed by a water-based resin composition through an emulsion polymerization reaction, and the water-based resin composition includes: water, mixed monomers, and an emulsifier; wherein the mixed monomers include: a first monomer, a second monomer, a third monomer, and a fourth monomer; wherein the first monomer is an acrylate monomer, the second monomer is an alkyl-containing methacrylate monomer, the third monomer is a styrene group-containing monomer, and the fourth monomer is a carboxyl group-containing monomer.

3. The water-based thermal-insulation coating material according to claim 2, wherein a weight ratio of water, the first monomer, the second monomer, the third monomer, the fourth monomer, and the emulsifier is 110 to 150:20 to 50:5 to 30:15 to 40:10 to 35:1 to 5.

4. The water-based thermal-insulation coating material according to claim 3, wherein the weight ratio of water, the first monomer, the second monomer, the third monomer, the fourth monomer, and the emulsifier is 120 to 140:30 to 45:8 to 25:20 to 35:15 to 30:2 to 5.

5. The water-based thermal-insulation coating material according to claim 4, wherein the minimum film-forming temperature of the water-based resin is not less than 25° C.

6. The water-based thermal-insulation coating material according to claim 5, wherein the minimum film-forming temperature of the water-based resin is between 25° C. and 45° C.

7. The water-based thermal-insulation coating material according to claim 1, wherein the film forming auxiliary agent has a boiling point of between 200° C. and 400° C., and has the following volatility characteristics:
(1) the film forming auxiliary agent has a relative volatilization rate of from 0.005 to 5 based on a volatilization rate of butyl acetate being 100; and (2) the film forming auxiliary agent has an absolute volatilization rate of from 0.1 g/(1000 cm² h) to 1.0 g/(1000 cm² h) measured at 100° C.

8. The water-based thermal-insulation coating material according to claim 1, wherein the hydrated silicon dioxide is prepared by a sol-gel method, and is anionic particles; wherein each of the anionic particles has a specific surface area of between 30.1 m²/g and 100 m²/g.

9. The water-based thermal-insulation coating material according to claim 1, further comprising: inorganic powders, wherein the inorganic powders are selected from the group consisting of: titanium dioxide, aluminum hydroxide, magnesium hydroxide, calcium carbonate, calcium phosphate, calcium sulfate, aluminum oxide, zirconium dioxide, zinc oxide, talcum powders, kaolin clay, muscovite, expanded perlite, and inorganic colorants.

10. The water-based thermal-insulation coating material according to claim 1, wherein, based on a total weight of the water-based thermal-insulation coating material being 100 wt %, a content of the water-based resin is between 55 wt % and 85 wt %, a content of the film forming auxiliary agent is between 2 wt % and 20 wt %, and a content of the thermal insulation agent is between 1 wt % and 10 wt %.
